(19) United States
(12) Patent Application Publication
(10) Pub. No.: US 2026/0267077 A1
(43) Pub. Date: Sep. 10, 2026

(54) Counterbalancing Torque Element for Fiber Optic Components

(71) Applicant: Legrand DC, LLC, West Hartford, CT (US)

(72) Inventors: Ryan J. Grandidge, Wakefield, RI (US); Daniel M. Smith, Westerly, RI (US); Kenneth A. Cupples, New London, CT (US)

(73) Assignee: Legrand DC, LLC, West Hartford, CT (US)

(21) Appl. No.: 19/665,115

(22) Filed: May 1, 2026

Related U.S. Application Data
(63) Continuation-in-part of application No. 19/377,850, filed on Nov. 3, 2025.
(60) Provisional application No. 63/715,743, filed on Nov. 4, 2024.

(51) Int. Cl. G02B 6/38

(52) U.S. Cl. CPC G02B 6/3825; G02B 6/3834

(57) ABSTRACT

An example counterbalancing element for a fiber optic connector-receiving component includes a flexible body section configured and dimensioned to be at least partially inserted into the interior of the fiber optic connector-receiving component through the opening of the fiber optic connector-receiving component. The counterbalancing element includes means for retaining the flexible body section relative to the fiber optic connector-receiving component such that the flexible body section remains at least partially within the interior of the fiber optic connector-receiving component. The flexible body section is configured to be displaced upon insertion of the fiber optic connector into the opening of the fiber optic connector-receiving component. Displacement of the flexible body section imparts a biasing force on the fiber optic connector.

### CROSS-REFERENCE TO RELATED APPLICATIONS

This application is a continuation-in-part application which claims the benefit of U.S. Non-Provisional Patent Application No. Ser. No. 19/377,850, filed on Nov. 3, 2025, which claims the benefit of commonly assigned U.S. Provisional Patent Application No. 63/715,743, filed on Nov. 4, 2024. The entire content of each of the foregoing applications is incorporated herein by reference.

### BACKGROUND

Media patching systems of the telecommunications industry are capable of receiving optical fibers in a variety of manners. In some instances, fiber optic adapters are used to receive fiber connectors (e.g., MMC connectors, or the like), and media patching panels are configured to receive such fiber optic adapters for easier, grouped installation and/or removal. When releasably coupling fiber optic connectors within the adapter, alignment of the optical fiber positions between the opposing connectors is essential to achieving optimal performance.

FIGS. 1 and 2 show a conventional fiber optic adapter 100 capable of receiving fiber optic connectors 150, 152 (e.g., MMC connectors) on opposing sides for mating within the interior of the adapter 100. The adapter 100 generally includes a body 102 with openings 116, 118 on opposing sides configured to receive the faces 154, 156 of the respective connectors 150, 152. In particular, the adapter 100 generally includes a body 102 defining a top surface or wall 104, an opposing bottom surface or wall 106, and opposing side surfaces or walls 108, 110. In general, the top and bottom walls 104, 106 extend parallel to each other, and the side walls 108, 110 similarly extend parallel to each other. The adapter 100 includes a front or first face 112 at one end of the adapter 100, and a rear or second face 114 at the opposing end of the adapter 100. Each face 112, 114 includes the respective opening 116, 118 (e.g., ports) formed therein and extending into a shared hollow interior 120 of the adapter 100 in which optical connection of optical fibers can be achieved.

The interior 120 of the adapter 100 includes tracks 122, 124 formed therein and configured to slidably receive a respective fiber optic connector 150, 152 (e.g., an MMC connector). In particular, the interior 120 includes upper and lower guides 126, 128 aligned with each other and defining the respective tracks 122, 124 for each fiber optic connector 150, 152 to be inserted into the adapter 100. The guides 126, 128 can be in the form of perpendicular extensions that extend from the inner surface 134 of the top wall 104 and the inner surface 136 of the bottom wall 106, respectively, into the interior 120. The inner surfaces 134, 136 generally extend in a flat or planar manner between the opposing faces 112, 114.

As illustrated in FIG. 1, the adapter includes four sets of tracks 122, 124, and is therefore capable of receiving up to four fiber optic connectors 150, 152. One of the walls 104-110 (e.g., the top wall 104) includes slots or openings 130, 132 formed therein and extending into the interior 120. The openings 130, 132 are configured to receive latches 158, 160 of respective fiber optic connectors 150, 152 to engage with and maintain the position of the connectors 150, 152 relative to each other and the adapter 100. In particular, each connector 150, 152 generally includes a spring-loaded retaining latch 158, 160 configured to snap into a respective opening 130, 132 formed in the body 102 of the adapter 100 to releasably retain the position of the connector 150, 152 relative to the adapter 100.

As the connectors 150, 152 are inserted into the adapter 100, the opposing ferrules 162, 164 are intended to mate with each other to form the optical connection between the connectors 150, 152. The ferrules 162, 164 are generally spring-loaded within the respective connectors 150, 152 along a direction or axis 166 perpendicular to a vertical, central mating axis or plane 168 defining the mating plane. However, the connectors 150, 152 are mechanically unbalanced due to the positioning of the retaining latches 158, 160. In particular, the latch points formed by the latches 158, 160 and the openings 130, 132 in the adapter 100 are offset vertically from the mating ferrules 162, 164. Because the ferrules 162, 164 are spring-loaded, a centered spring force is counteracted by opposite retaining forces which are not aligned with each other.

This misalignment or unbalance of forces creates a torque on each respective connector 150, 152, which encourages both connectors 150, 152 to rotate slightly about their respective latch points (i.e., at latches 158, 160) away from the mating plane 168. For example, the connector 150 rotates slightly in a clockwise direction 170, and the connector 152 rotates slightly in a counter-clockwise direction 172. Such rotation creates a closer or stronger contact between the connectors 150, 152 at the upper point closest to the latches 158, 160, as compared to a slight separation or reduced contact pressure at the bottom point furthest from the latches 158, 160. Specifically, the contact pressure on the ferrule 162, 164 surfaces is also unbalanced, with greater contact pressure at the top or upper point closest to the latches 158, 160, and the least contact pressure at the bottom point furthest from the latches 158, 160. In some instances, the unbalanced forces can result in a gap between the ferrules 162, 164 at the bottom point along the mating plane 168. Therefore, the unbalanced contact pressure between the ferrules 162, 164 results in reduced optical performance at the connection between the connectors 150, 152, and can undermine polish quality.

Although discussed with respect to an adapter, similar unbalanced contact pressure can occur in a receptacle configured to receive a connector, or a polishing, measurement and/or testing fixture having a structure configured to receive a connector. In such applications, the face 154 of connector 150 can bear against a fixed surface or surfaces, generating a torque which will be approximately half of that generated in the adapter of FIGS. 1 and 2. Though reduced in magnitude, this torque can still undermine performance in receptacle and test fixture applications by encouraging fiber misalignment, and can undermine polish quality by causing uneven abrasion across the fiber end faces. Such torque is therefore still undesirable for the connector's intended purposes.

### SUMMARY

Embodiments of the present disclosure provide a counterbalancing torque element configured to be incorporated into or built into a fiber optic adapter, a receptacle (e.g., transceiver, plug, or the like) configured to receive a connector, an active device receptacle, a port, or a polishing, measurement and/or testing fixture having a structure configured to receive a connector (collectively referred to herein as a “connector-receiving component”). Thus, although adapters may be discussed herein, it should be understood that the counterbalancing torque elements can be incorporated into any type of connector-receiving component to assist with achieving a balanced contact pressure on ferrules of the connector. In some embodiments, the counterbalancing torque elements can be incorporated into a housing of a connector, such that the balanced contact pressure is provided by the connector rather than the adapter or receptacle.

The counterbalancing torque element reduces or prevents the misalignment or unbalance of forces when fiber optic connectors (e.g., MMC connectors) are engaged with the adapter. In particular, the counterbalancing elements create an opposing torque force on the bottom surface of the connectors, which reduces or prevents the bias typically encountered from latches that results in near-latch and distant-from-latch ferrule alignment. Incorporation of the counterbalancing elements in the adapter encourages the mated connectors to mate more evenly, ensuring a more uniform distribution of the spring force on the ferrules. By providing a more uniform mating between the ferrules of the opposing connectors, variability of optical performance is prevented, allowing achievement of higher optical performance levels.

In accordance with embodiments of the present disclosure, an exemplary counterbalancing element for a fiber optic adapter is provided. The fiber optic adapter includes a body defining a proximal end and a distal end, and a first opening extending into an interior of the body from the proximal end. The first opening is configured to accept a first fiber optic connector. The fiber optic adapter includes a second opening extending into the interior of the body from the distal end. The second opening is configured to accept a second fiber optic connector. The counterbalancing element includes a flexible body section configured and dimensioned to be at least partially inserted into the interior of the fiber optic adapter through the first opening or the second opening of the fiber optic adapter. The counterbalancing element includes means for retaining the flexible body section relative to the fiber optic adapter such that the flexible body section remains at least partially within the interior of the fiber optic adapter. The flexible body section is configured to be displaced upon insertion of at least one of the fiber optic connector or the second fiber optic connector into the respective first or second opening of the fiber optic adapter. Displacement of the flexible body section imparts a biasing force on at least one of the first fiber optic connector or the second fiber optic connector.

In some embodiments, the flexible body section can be fabricated from spring steel, a resilient material, or the like. The flexible body section can extend between proximal and distal ends of the flexible body section. In some embodiments, the flexible body section can define a convex configuration relative to horizontal between the proximal and distal ends of the flexible body section.

The flexible body section extends between a first edge at a proximal end of the flexible body section and a second edge at a distal end of the flexible body section. In some embodiments, the counterbalancing element can include a first flange extending from the first edge and a second flange extending from the second edge. The first and second flanges can extend perpendicularly from the first and second edges, and extend parallel to each other. In some embodiments, the counterbalancing element can include a lip extending inwardly from the second flange and under the flexible body section. The first flange can be configured to be positioned against a face of the body of the fiber optic adapter at the first opening and the second flange can be configured to be positioned against a face of the body of the fiber optic adapter at the second opening to secure the counterbalancing element relative to the fiber optic adapter.

In accordance with embodiments of the present disclosure, an exemplary fiber optic adapter is provided. The fiber optic adapter includes a body defining a proximal end and a distal end. The fiber optic adapter includes a first opening extending into an interior of the body from the proximal end. The first opening is configured to accept a first fiber optic connector. The fiber optic adapter includes a second opening extending into the interior of the body from the distal end. The second opening is configured to accept a second fiber optic connector. The fiber optic adapter includes a counterbalancing element. The counterbalancing element includes a flexible body section configured and dimensioned to be at least partially disposed within the interior of the body. The flexible body section is configured to be displaced upon insertion of at least one of the first fiber optic connector or the second fiber optic connector into the respective first or second opening. Displacement of the flexible body section imparts a biasing force on at least one of the first fiber optic connector or the second fiber optic connector.

The first and second openings can be configured to accept the respective first and second fiber optic connectors for a mating engagement within the interior of the body. The fiber optic adapter includes a first latching point formed in the body and configured to releasably engage with the first fiber optic connector to maintain the first fiber optic connector within the first opening. The fiber optic adapter includes a second latching point formed in the body and configured to releasably engage with the second fiber optic connector to maintain the second fiber optic connector within the second opening.

The counterbalancing element can be configured to impart the biasing force on at least one of the first fiber optic connector or the second fiber optic connector to achieve a uniform mating engagement between the first and second fiber optic connectors. The counterbalancing element can be configured to impart the biasing force on at least one of the first fiber optic connector or the second fiber optic connector to achieve the uniform mating engagement between ferrules of the first and second fiber optic connectors. The biasing force can be a counterbalancing force configured to counter an opposing torque force during latching of the first and second fiber optic connectors with respective first and second latching points formed in the body.

In accordance with embodiments of the present disclosure, an exemplary fiber optic adapter system is provided. The system includes a fiber optic adapter including a body defining a proximal end and a distal end, and a first opening extending into an interior of the body from the proximal end. The first opening is configured to accept a first fiber optic connector. The fiber optic adapter includes a second opening extending into the interior of the body from the distal end. The second opening is configured to accept a second fiber optic connector. The system includes a counterbalancing element. The counterbalancing element includes a flexible body section configured and dimensioned to be at least partially inserted into the interior of the fiber optic adapter through the first opening or the second opening of the fiber optic adapter. The counterbalancing element includes means for retaining the flexible body section relative to the fiber optic adapter such that the flexible body section remains at least partially within the interior of the fiber optic adapter. The flexible body section is configured to be displaced upon insertion of at least one of the fiber optic connector or the second fiber optic connector into the respective first or second opening of the fiber optic adapter. Displacement of the flexible body section imparts a biasing force on at least one of the first fiber optic connector or the second fiber optic connector.

The counterbalancing element can extend entirely through the interior of the fiber optic adapter. The flexible body section can extend between a first edge at a proximal end of the flexible body section and a second edge at a distal end of the flexible body section. In some embodiments, the counterbalancing element can include a first flange extending from the first edge and a second flange extending from the second edge. The counterbalancing element can include a lip extending inwardly from the second flange and under the flexible body section. The first flange can be configured to be positioned against a face of the body of the fiber optic adapter at the first opening and the second flange is configured to be positioned against a face of the body of the fiber optic adapter at the second opening to secure the counterbalancing element relative to the fiber optic adapter.

The first and second openings of the fiber optic adapter can be configured to accept the respective first and second fiber optic connectors for a mating engagement within the interior of the body of the fiber optic adapter. The counterbalancing element can be configured to impart the biasing force on at least one of the first fiber optic connector or the second fiber optic connector to achieve a uniform mating engagement between ferrules of the first and second fiber optic connectors.

In accordance with embodiments of the present disclosure, an exemplary counterbalancing element for a fiber optic connector-receiving component is provided. The fiber optic connector-receiving component includes a body defining a proximal end and a distal end, and an opening extending into an interior of the body. The opening is configured to accept a fiber optic connector. The counterbalancing element includes a flexible body section configured and dimensioned to be at least partially inserted into the interior of the fiber optic connector-receiving component through the opening of the fiber optic connector-receiving component. The counterbalancing element includes means for retaining the flexible body section relative to the fiber optic connector-receiving component such that the flexible body section remains at least partially within the interior of the fiber optic connector-receiving component. The flexible body section is configured to be displaced upon insertion of the fiber optic connector into the opening of the fiber optic connector-receiving component. Displacement of the flexible body section imparts a biasing force on the fiber optic connector.

In some embodiments, the flexible body section can be fabricated from spring steel or a resilient material. In some embodiments, the flexible body section can extend between proximal and distal ends of the flexible body section. The flexible body section can define a convex configuration relative to horizontal between the proximal and distal ends of the flexible body section.

In some embodiments, the flexible body section can extend between a first edge at a proximal end of the flexible body section and a second edge at a distal end of the flexible body section. The counterbalancing element can include a first flange extending from the first edge and a second flange extending from the second edge. In some embodiments, the first and second flanges can extend perpendicularly from the first and second edges, and can extend parallel to each other. In some embodiments, the counterbalancing element can include a lip extending inwardly from the second flange and under the flexible body section. In some embodiments, the first flange can be configured to be positioned within a slit formed in the body of the fiber optic connector-receiving component and the second flange can be configured to be positioned against a face of the body of the fiber optic connector-receiving component to secure the counterbalancing element relative to the fiber optic connector-receiving component.

In accordance with embodiments of the present disclosure, an exemplary fiber optic connector-receiving component is provided. The component includes a body defining a proximal end and a distal end, and an opening extending into an interior of the body. The opening is configured to accept a fiber optic connector. The component includes a counterbalancing element. The counterbalancing element includes a flexible body section configured and dimensioned to be at least partially disposed within the interior of the body. The flexible body section is configured to be displaced upon insertion of the fiber optic connector into the opening. Displacement of the flexible body section imparts a biasing force on the fiber optic connector.

In some embodiments, the counterbalancing element can be configured to impart the biasing force on the fiber optic connector to maintain alignment of ferrules of the fiber optic connector relative to the body of the fiber optic connector-receiving component. In some embodiments, the biasing force can be a counterbalancing force configured to counter an opposing torque force during latching of the fiber optic connector with a latching point formed in the body. In some embodiments, the fiber optic connector-receiving component can be an active device receptacle and the biasing force on the fiber optic connector can maintain alignment of ferrules of the fiber optic connector relative to an active device.

In some embodiments, the fiber optic connector-receiving component can be associated with a polishing fixture and the biasing force on the fiber optic connector can maintain alignment of ferrules of the fiber optic connector relative to a polishing surface. In some embodiments, the component can include an adjustment mechanism configured to engage with the counterbalancing element to selective increase or decrease the biasing force imparted by the flexible body section of the counterbalancing element on the fiber optic connector. The adjustment mechanism can include a feedback control loop including a controller configured to receive optical performance in real-time associated with the fiber optic connector and to automatically adjust the biasing force imparted on the fiber optic connector with the counterbalancing element to optimize the optical performance.

In accordance with embodiments of the present disclosure, an exemplary fiber optic connector-receiving component system is provided. The system includes a fiber optic connector-receiving component including a body defining a proximal end and a distal end, an opening extending into an interior of the body (the opening configured to accept a fiber optic connector), and a counterbalancing element. The counterbalancing element includes a flexible body section configured and dimensioned to be at least partially inserted into the interior of the fiber optic connector-receiving component through the opening of the fiber optic connector-receiving component. The counterbalancing element includes means for retaining the flexible body section relative to the fiber optic connector-receiving component such that the flexible body section remains at least partially within the interior of the fiber optic connector-receiving component. The flexible body section is configured to be displaced upon insertion of the fiber optic connector into the opening of the fiber optic connector-receiving component. Displacement of the flexible body section imparts a biasing force on the fiber optic connector.

In some embodiments, the body of the fiber optic connector-receiving component can include a track configured and dimensioned complementary to the fiber optic connector. In some embodiments, the component can include a slit formed in a bottom surface of the track and offset from the proximal end or the distal end of the body. In some embodiments, a first flange of the counterbalancing element can be configured to be positioned within the slit and a second flange of the counterbalancing element can be configured to be positioned against a face of the body of the fiber optic connector-receiving component to secure the counterbalancing element relative to the fiber optic connector-receiving component.

In some embodiments, the fiber optic connector-receiving component can include an adjustment mechanism configured to engage with the counterbalancing element to selective increase or decrease the biasing force imparted by the flexible body section of the counterbalancing element on the fiber optic connector. In some embodiments, the adjustment mechanism can include a feedback control loop including a controller configured to receive optical performance in real-time associated with the fiber optic connector and to automatically adjust the biasing force imparted on the fiber optic connector with the counterbalancing element to optimize the optical performance.

Any combination and/or permutation of embodiments is envisioned. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the counterbalancing torque element for a fiber optic component, reference is made to the accompanying figures, wherein:

FIG. 1 is a perspective view of a conventional fiber optic connector adapter capable of receiving fiber optic connectors on opposing sides.

FIG. 2 is a cross-sectional view of a conventional connector adapter of FIG. 2 receiving fiber optic connectors on opposing sides.

FIG. 3 is a perspective view of an exemplary counterbalancing torque element for a fiber optic connector adapter.

FIG. 4 is a perspective view of exemplary counterbalancing torque elements engaged with a fiber optic connector adapter of FIGS. 1 and 2.

FIG. 5 is a cross-sectional view of exemplary counterbalancing torque elements engaged with a fiber optic connector adapter of FIGS. 1 and 2.

FIG. 6 is a perspective view of an exemplary counterbalancing torque element for a fiber optic component.

FIG. 7 is a front, perspective view of an exemplary fiber optic component including a counterbalancing torque element of FIG. 7, the fiber optic component being in the form of a receptacle or port.

FIG. 8 is a top, perspective view of an exemplary fiber optic component of FIG. 7.

FIG. 9 is a side view of an exemplary fiber optic component of FIG. 7.

FIG. 10 is a cross-sectional, perspective view of an exemplary fiber optic component of FIG. 7.

FIG. 11 is a perspective view of an exemplary fiber optic component of FIG. 7, including a tool for adjustment of a counterbalancing torque element position.

FIG. 12 is a cross-sectional, perspective view of an exemplary fiber optic component of FIG. 11.

FIG. 13 is a perspective view of an exemplary fiber optic component of FIG. 7, including a fiber optic connector engaged with the fiber optic component and the counterbalancing torque element of the fiber optic component.

FIG. 14 is a side view of an exemplary fiber optic component of FIG. 7, including a fiber optic connector engagement with the fiber optic component and the counterbalancing torque element of the fiber optic component.

FIG. 15 is a perspective view of an assembly of fiber optic components including a counterbalancing element, the assembly defining a polishing fixture.

FIG. 16 is a detailed, perspective view of an assembly of fiber optic components of FIG. 15.

FIG. 17 is a block diagram of a control system for regulating automatic adjustment of an exemplary counterbalancing torque element.

### DETAILED DESCRIPTION

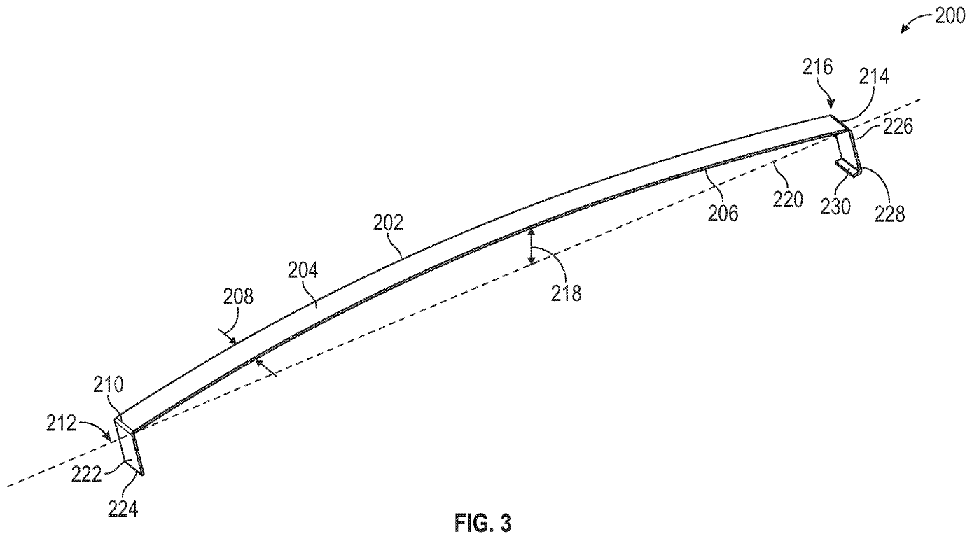

FIG. 3 is a perspective view of an exemplary counterbalancing torque element 200 (hereinafter “element 200”). The element 200 can be used with the fiber optic adapter 100, or can similarly be used with other similar adapters to achieve similar results. In some embodiments, the element 200 can be fabricated from, e.g., spring steel, a resilient material, or the like, to provide a resilient or spring-like effect due to the flexibility of the material. In some embodiments, the element 200 can be fabricated from, e.g., any resilient or elastomeric material. The material of the element 200 can be selected to be economical, least susceptible to fatigue, and easiest to design/form for a given adapter interface. The shape, material, thickness and/or heat treatment of the element 200 can be adjusted to balance out the torque of the mated connector pairs precisely in order to turn an unbalanced connection into a balanced one. Thus, characteristics of the element 200 can be adjusted depending on the adapter and/or connectors being used.

The element 200 generally includes an elongated body section 202 configured to impart the spring-like force on the connectors. The body section 202 defines a top surface 204 and an opposing bottom surface 206. The body section 202 is substantially flat or planar and can define a thickness (as measured between the top and bottom surfaces 204, 206). The thickness of the element 200 can depend on the material of fabrication of the element 200, the force required to counterbalance the connectors being mated within the adapter 100, or both. As a non-limiting example, if the element 200 is formed from an elastomeric material, the thickness can be greater than fabrication from a metal material. As a further non-limiting example, softer metals (e.g., beryllium copper, or the like) would necessitate a greater thickness than stronger metals (e.g., spring steel, or the like).

The force for counterbalancing the connectors can vary depending on the kind/type of connector being inserted. As a non-limiting example, 24F MMC connectors have a higher spring force than 16F MMC connectors. In some embodiments, the element 200 can be provided in different thicknesses to ensure the appropriate element 200 is used for adapters 100 configured to receive a specific type of connector. In some embodiments, a “universal” element 200 with the same thickness can be used with the understanding that the selected thickness will be sufficient to counterbalance any type of connector intended to be used with the adapter 100.

The width 208 of the body section 202 is measured between opposing side edges of the body section 202. In some embodiments, the entire length of the element 200 can define a uniform width 208. In some embodiments, the proximal and distal ends 212, 216 can have a greater width 208 to assist with fixation to opposing sides of the adapter 100. In general, the width 208 can be dimensioned to fit between and move freely vertically between the guides 128 of the adapter 100. In some embodiments, the width 208 can be substantially complementary to the space between the guides 128 of the adapter 100. In some embodiments, the width 208 of the element 200 can be varied based on the connector style/type being used with the adapter 100. Thus, an element 200 can be incorporated into each respective track 122 of the adapter 100 to function independently of each other.

The body section 202 extends from a first edge 210 at a proximal end 212 of the element 200 to a second edge 214 at a distal end 216 of the element 200. The edges 210, 214 extend perpendicularly to the extension direction of the body section 202, and substantially parallel to each other. The body section 202 is fabricated to define a convex or outwardly curved configuration such that a central point of the body section 202 is disposed at a height 218 offset from horizontal 220 passing through the respective edges 210, 214.

This height 218 differential and curvature allows the body section 202 to function as a spring. For example, pressure applied downward on the body section 202 can flex the body section 202 at least partially through the height 218 with the body section 202 imparting an opposing biasing force to return to “neutral” or “base” configuration shown in FIG. 3. This biasing force acts as a counterbalancing force on the connectors inserted into the adapter 100. Release of the pressure from the body section 202 allows the body section 202 to spring back to the “neutral” or “base” configuration shown in FIG. 3.

The element 200 includes a first flange 222 extending substantially perpendicularly from the first edge 210. The first flange 222 is formed from the same material as the body section 202 and can be formed by bending of the material at the first edge 210. The first flange 222 defines a length substantially equal to or smaller than the distance between the track 122 and the bottom wall 106 of the adapter 100. This length ensures that the endpoint edge 224 of the first flange 222 does not extend beyond the bottom wall 106 of the adapter 100.

The element 200 includes a second flange 226 extending substantially perpendicularly from the second edge 214. The second flange 226 is formed from the same material as the body section 202 and can be formed by bending of the material at the second edge 214. The first and second flanges 222, 226 can extend substantially parallel to each other. In some embodiments, the second flange 226 can be substantially similar to the first flange 222, and defines a length substantially equal to or smaller than the distance between the track 122 and the bottom wall 106 of the adapter 100. In such embodiments, the endpoint edge 228 of the second flange 226 can define the furthest structure of the element 200 at the distal end 216. In such embodiment, flanges 222, 226 can be positioned against respective faces 112, 114 of the adapter 100, and tension from the material of the element 100 can maintain the position of the element 100 within the track 122.

In some embodiments, the second flange 226 can define a length substantially equal to or slightly greater than the distance between the track 122 and the bottom wall 106 of the adapter 100. In such embodiments, the element 200 includes a securing flange or lip 230 extending perpendicularly from the edge 228 of the second flange 226 (e.g., extending substantially parallel to horizontal 220). The lip 230 can be formed from the same material as the second flange 226, e.g., by bending the material at the edge 228. The overall length of the lip 230 can be dimensioned equal to or smaller than the length of the second flange 226. The dimensions of the second flange 226 in such embodiment allow the lip 230 to hook around the bottom wall 206 of the adapter 100 to releasably secure the element 200 to the adapter 100 at one end, while the opposing end of the element 100 is maintained in position with the flange 222 due to the tension from the material of the element 100. In some embodiments, both flanges 222, 226 can include the lip 230 to allow for hook-like engagement of the element 200 on both sides. However, a single lip 230 can allow for easier installation and removal of the element 200 relative to the adapter 100.

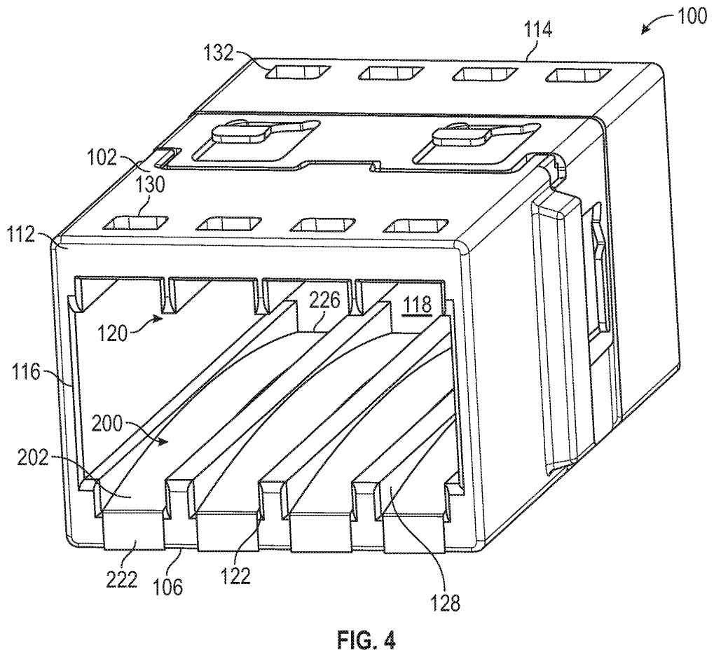

As an example, FIG. 4 shows the adapter 100 with elements 200 releasably secured within each individual track 122. For installation, the element 200 can be passed through the interior 120 of the adapter 100 such that the lip 230 can be hooked around the bottom wall 106 at the face 114 of the adapter 100 (e.g., first attachment means). Next, the element 200 can be pivoted downward such that the flange 226 rests against the face 114 and the flange 222 is positioned against the face 112 of the adapter 100 (e.g., second attachment means). The element 200 can therefore clip or hook onto the edges of the adapter 100. The spring-like or flexible forces of the element 200 create a tension on the opposing faces 112, 114, such that the element 200 can remain in place on the adapter 100. This tension can be sufficient enough to maintain the elements 200 in place (e.g., avoiding shifting in the adapter 100), and insertion of a fiber optic connector into the adapter 100 further ensures the elements 200 are in the appropriate position. In some embodiments, rather than a separate component configured to be installed into the adapter 100, the element 200 can be built into the adapter 100 itself.

The curved configuration of the element 200 maintains the body section 202 elevated above the planar inner surface 134 of the track 122. The topmost surface of the body section 202 (e.g., at the center of the body section 202) can be positioned evenly with the top surface of the guides 128, or can be positioned below the top surface of the guides 128. However, the curvature of the body section 202 ensures that the body section 202 edges 210, 214 are substantially adjacent to the edges formed by connection of the respective faces 112, 114 and the tracks 122. Thus, the guides 128 are exposed to a greater extent at the openings 116, 118 of the adapter 100 to successfully guide insertion and removal of fiber optic connectors.

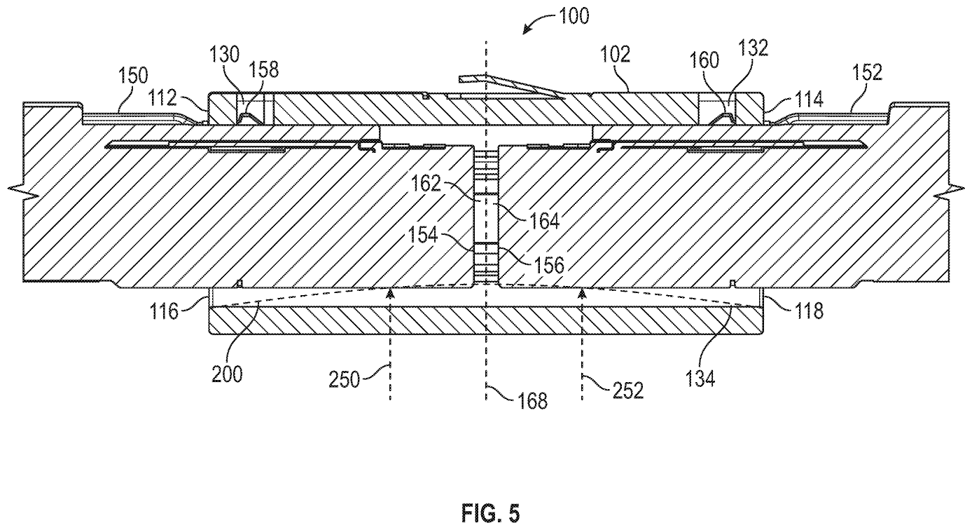

FIG. 5 is a cross-sectional view of the adapter 100 including the element 200. Each connector 150, 152 can be independently inserted into the respective port of the adapter 100. During insertion, the connector 150, 152 applies a downward force on the element 200, with the force increasing as the connector 150, 152 is pushed further towards the mating plane 168. This downward force at least partially compresses the element 200 towards the inner surface 134 of the track 122. However, the biasing force from the element 200 imparts an opposing upward force 250, 252 (e.g., a counterbalancing reactive force) on each respective connector 150, 152.

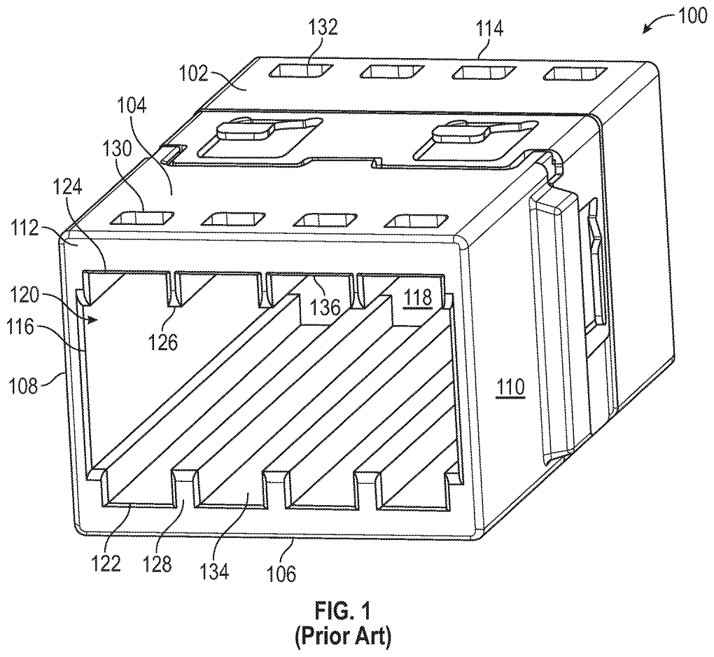

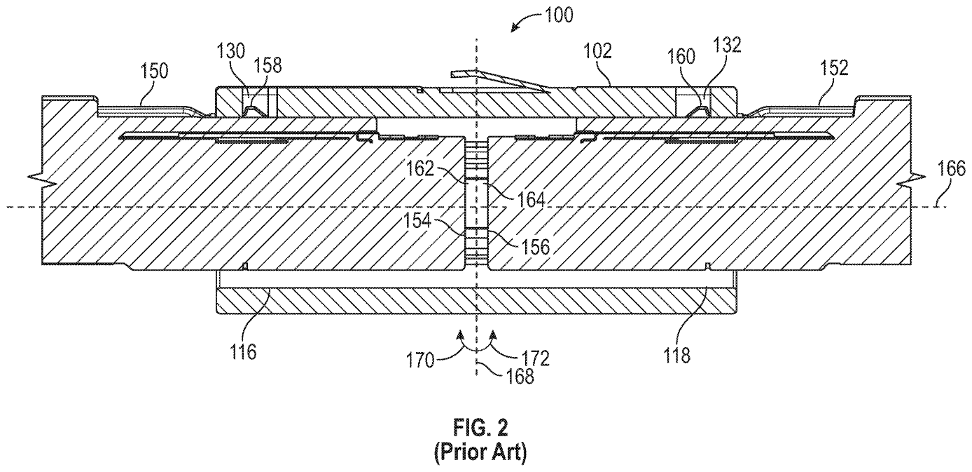

In particular, by including the element 200 at the bottom of the adapter 100 (or, more importantly, on the opposite side of the adapter 100 from the latching openings 130, 132), the element 200 imparts a counterbalancing torque or force 250, 252 on the connectors 12, 14 mated within the adapter 100. This counterbalancing force 250, 252 opposes the mating torque typically created from latching of the connectors 150, 152 with the adapters (as discussed with respect to FIGS. 1 and 2). As shown in FIG. 5, the counterbalancing forces 250, 252 are substantially perpendicular to the spring force of the ferrules 162, 164 (which extend substantially along axis 166). The counterbalancing forces 250, 252 apply a reactive force to the inserted fiber optic connector 150, 152 which applies a torque in the opposite direction to the torque applied by the ferrule 162, 164 spring compression relative to the force of the connector 150, 152 retention.

As such, the element 200 encourages the mated connectors 150, 152 to mate more evenly, e.g., substantially aligned mating of the ferrules 162, 164 along the mating plane 168. This does not affect the overall spring force applied by the connector 150, 152 springs on the ferrules 162, 164, but results in a more uniform pressure distribution from the spring force. The element 200 thereby reduces the variability of optical performance which would ordinarily result from lack of uniformity of the spring forces. Inclusion of the element 200 in the adapter 100 allows for high optical performance to be achieved during connectivity of optical fiber connectors 150, 152 within the adapter 100.

The elements 200 discussed herein are shown as extending the full length of the adapter 100, thereby providing a counterbalancing force on both sides of the adapter 100 to the respective connectors 150, 152. However, in some embodiments, only one side of the adapter 100 may necessitate the counterbalancing force. For example, the connectors 150 used on one side of the adapter 100 may be mechanically balanced relative to the mating plane 168, and applying the counterbalancing force on such connectors 150 can create misalignment instead. Therefore, in some embodiments, the elements 200 can be dimensioned to extend only halfway within the adapter 100 to apply the counterbalancing force only to one side, e.g., connectors 152. In such embodiments, the interior of the adapter 100 can include a slot or other engagement means to couple with the endpoint of the element 200, allowing for retention of the element 200 relative to the adapter 100.

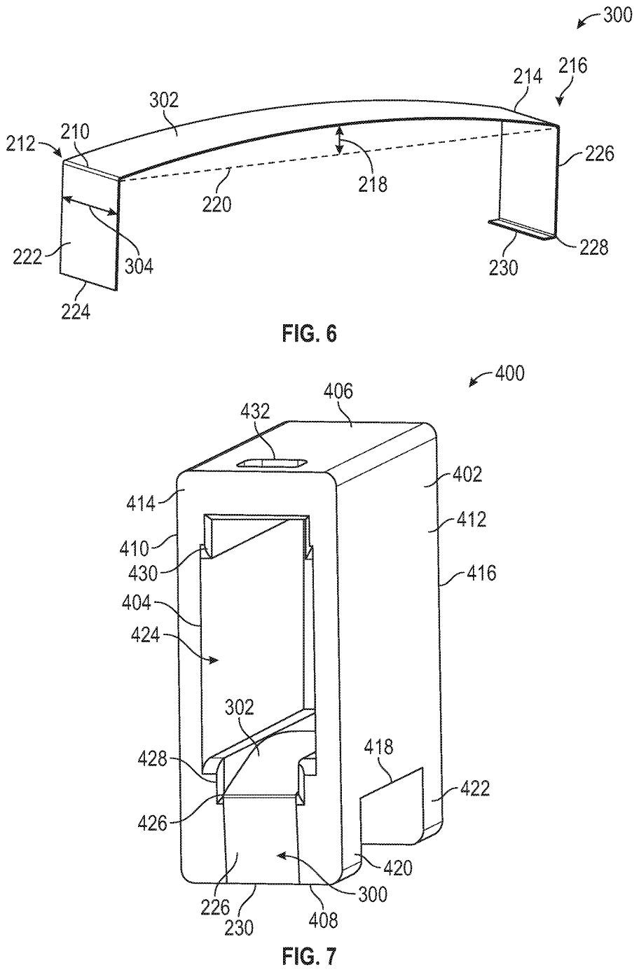

In some embodiments, the counterbalancing torque elements discussed herein can be used with any type of connector-receiving component, non-limiting examples of which can include, e.g., a receptacle, an active device receptacle, a port, a polishing fixture, a measurement fixture, a testing fixture, or the like. FIG. 6 is a perspective view of an exemplary counterbalancing torque element 300 usable with such connector-receiving components (e.g., fiber optic connector-receiving component). The element 300 can be substantially similar in structure and/or function to the element 200, except for the distinctions noted herein. In particular, the overall length of the body section 302 (as measured from flange 222 to flange 226) can be dimensioned shorter than the overall length of the body section 202 of the element 200. As a non-limiting example, the length of the body section 202 can be about half for the element 300. The shorter length of the body section 302 can be configured to provide the counterbalancing force to a single connected received by the component, as compared to the longer element 200 which provides the counterbalancing force to two facing connectors. In some embodiments, a width 304 of the body section 302 (and flanges 222, 226, 230) can be dimensioned wider than the width of the complementary sections of the element 200.

FIGS. 7-10 are perspective and cross-sectional views of an exemplary connector-receiving component 400, which is in the form of a receptacle configured to receive a connector. For visualization, the component 400 is shown with both sides open. However, it should be understood that the component 400 can be an active device receptacle with one side open for insertion of a fiber optic connector, and the opposing side positioned against an active device for fiber optic connectivity with the connector. The component 400 generally includes a body 402 including an opening 404 extending therethrough. The opening 404 leads into a hollow interior 424 which can be configured and dimensioned to receive a fiber optic connector (e.g., MMC connector, MDC connector, or the like) at least partially therethrough. The component 400 can include a top wall 406, an opposing bottom wall 408 extending substantially parallel to the top wall 406, and side walls 410, 412 extending substantially parallel to each other and connecting the top and bottom walls 406, 408.

The component 400 includes a first face 414 at one end (e.g., proximal end) of the component 400 and a second face 416 at the opposing end (e.g., distal end) of the component 400. The first and second faces 414, 416 can extend substantially parallel to each other, with the opening 404 formed in each of the faces 414, 416 and extending into the interior 424 of the body 402. In some embodiments, the bottom wall 408 can include a substantially U-shaped cutout 418 formed therein and extending towards the opening 404 (or interior) of the body 402, such that two posts or flanges 420, 422 extend downwardly from the cutout 418 at opposing faces 414, 416. The flange 420 is therefore aligned with the face 414, and the flange 422 is aligned with the face 416.

The interior 424 includes a channel or track 426 formed therein and configured to slidably receive a fiber optic connector. The track 426 can include a stepped configuration on opposing lateral sides and defined by opposing stepped lower guides 428. The lower guides 428 are formed at or near the bottom surface or area of the interior 424. The interior 424 further includes a stepped upper guides 430 formed at or near the top surface or area of the interior 424. The guides 428, 430 generally extend inwardly from the side walls of the interior 424 to define a narrower passage than the middle section of the interior 424, with the configuration dimensioned to accommodate sliding entry of at least a portion of a fiber optic connector. The component 400 includes a slot or opening 432 formed in the top wall 406 and extending into the interior 424. The opening 432 is configured and dimensioned to engage with a latch of the fiber optic connector to releasably retain at least a portion of the fiber optic connector within the interior 424.

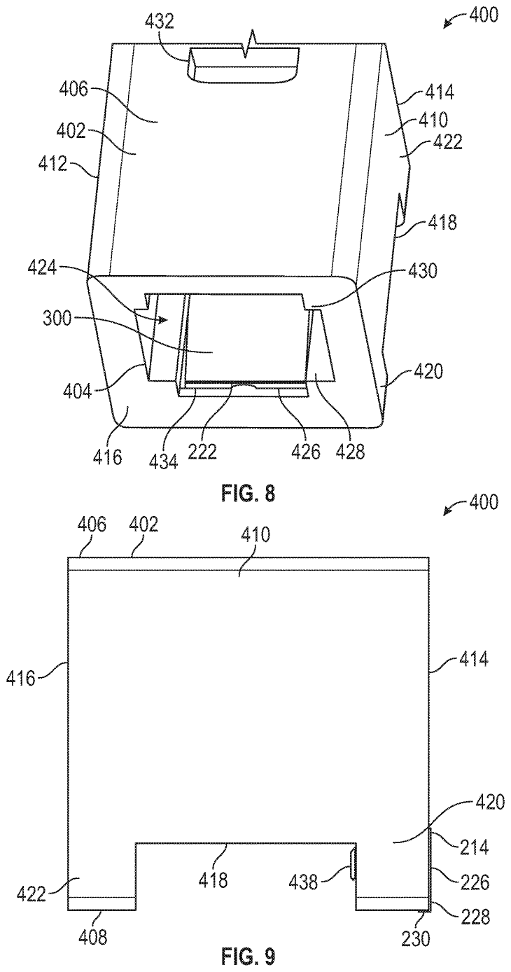

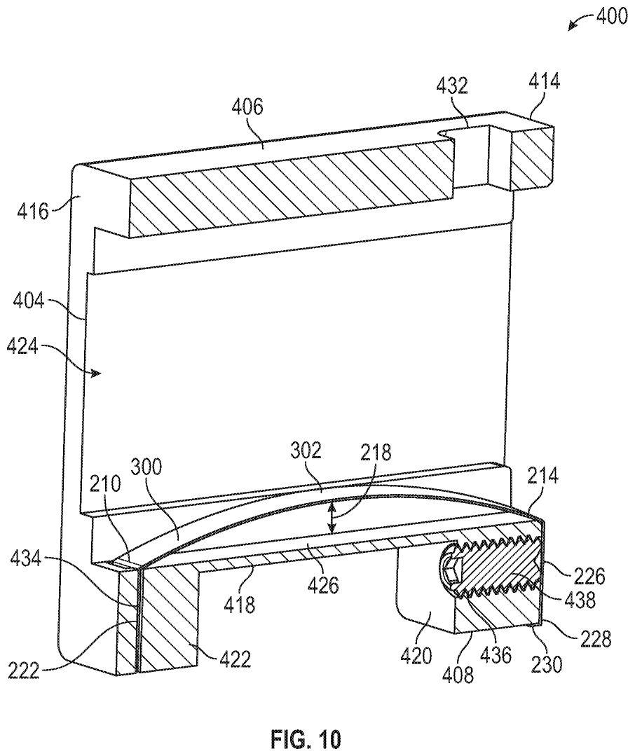

The component 400 includes a groove or slit 434 formed adjacent to and offset from the face 416 (see, e.g., FIGS. 8 and 10). The slit 434 forms a channel extending downwardly from the bottom surface of the track 426, with the slit 434 extending parallel to the face 416. The width, thickness and depth of the slit 434 are dimensioned to at least partially receive therethrough the flange 222 of the element 300, thereby retaining one end of the element 300 relative to the component 400. In particular, during assembly of the element 300 with the component 400, the element 300 can be passed through the interior 424 such that the lip 230 can be hooked around the bottom wall 408 of the flange 420 at the face 414 (e.g., first attachment means).

Next, the element 300 can be pivoted downward within the interior 424 such that the flange 226 rests against the face 414 and the flange 222 is positioned and press fit into the slit 434 until the edge 210 is substantially adjacent to the bottom surface of the track 426. The element 300 can thereby clip or hook onto the edge and slit 434 of the component 400. The spring-like or flexible forces of the element 300 create a tension on the face 414 and the slit 434, such that the element 300 can remain in place on the component 400. This tension can be sufficient enough to maintain the element 300 in place (e.g., avoiding shifting in the component 400).

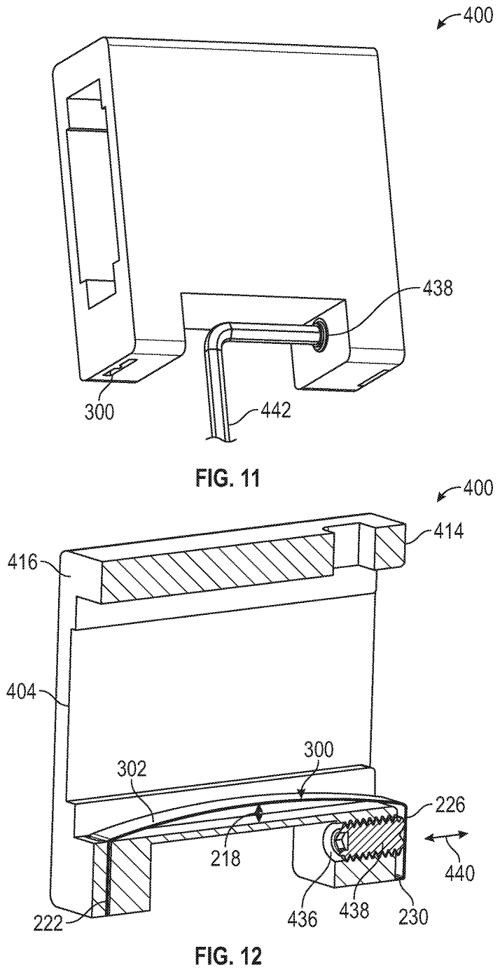

The flange 420 of the component 400 includes an opening 436 extending therethrough perpendicular to the face 414. The opening 436 extends through the ace 414, and similarly extends on the opposing face of the flange 420 and into the cutout 418 area of the component 400. The opening 436 is tapped such that a set screw 438 can be threaded within the opening 436 (see, e.g., FIGS. 10-12). A tool 442, such as a hex key, can be used to selectively thread the set screw 438 further into the opening 436 (e.g., clockwise), which causes the end of the set screw 438 to extend at least partially out of the opening 436 at the face 414. Such extension of the set screw 438 abuts against the flange 226, which laterally moves or stretches the element 300 along direction 440 perpendicular to the face 414. In particular, the element 300 or “spring” is flexed downward as the set screw 438 is engaged with the flange 226.

By laterally moving the element 300 further away from the face 414, the offset height 218 of the body 302 relative to the track 426 (and horizontal 220) can be reduced. This reduction results in less counterbalancing force applied by the element 300 against the bottom surface of a fiber optic connector inserted into the component 400. Alternatively, counterclockwise rotation of the set screw 438 withdraws the set screw 438 away from the face 414, reducing the tension on the element 300 and increasing the offset height 218 (relative to the track 426 and horizontal 220). This increased offset height 218 results in a greater counterbalancing force applied by the element 300 against the bottom surface of a fiber optic connector inserted into the component 400. The set screw 438 therefore defines an adjustment mechanism, allowing for selective adjustment of the amount of counterbalancing force applied by the element 300 against the fiber optic connector. It should be understood that the set screw 438 is a non-limiting example of an adjustment mechanism capable of being used with the component 400. In some embodiments, one or more different types of adjustment mechanisms can be used that allow for similar adjustability of the counterbalancing force, accommodating for customization of such force in many (but not all) applications of the component 400 and/or the element 300.

In some embodiments, rather than a manually adjustable set screw 438, the adjustment mechanism can include a servomotor that can be actuated in real-time to adjust the tension in the element 400 upon detection of the connector within the component 400. For example, the component 400 can include a sensor that detects insertion of the connector and the performance level of the connector. The servomotor can be actuated in a real-time with a controller to test the full torque range provided by the element 300, simultaneously detecting the performance level of the connector at each torque position. The controller identifies the torque position of the element 300 which results in the best or optimal performance of the connector, and sets the element 300 to the optimal torque position. The torque provided by the element 300 can thereby be optimized, and can be adjusted in real-time to maintain optimal alignment and performance of the connector. In some embodiments, thermal conditions may change within the port of the component 400, resulting in a change in the toque forces imparted by the element 300 within the connector port. Thus, the real-time (or substantially real-time) adjustability of the torque force imparted by the element 300 on the connector can advantageously accommodate such thermal condition changes (and/or any other similar effects on the element 300).

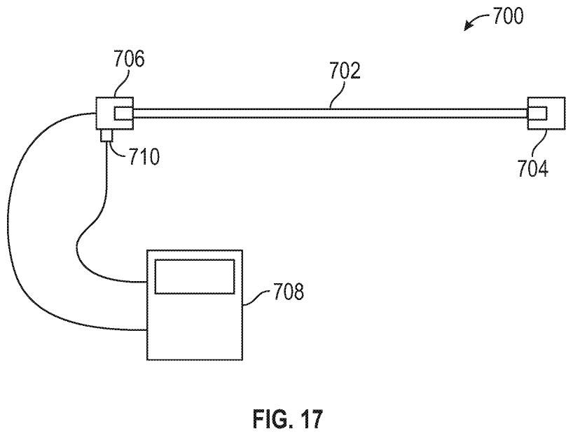

As noted above, in some embodiments, adjustability of the counterbalancing element can be performed in an automated manner and in real-time (or substantially real-time). FIG. 17 is a block diagram of a control system 700 for regulating automatic adjustment of an exemplary counterbalancing torque element. The system 700 therefore provides for adjustable counterbalancing action of the fiber optic component. Fiber cable assembly 702 can be connected at one end to an ordinary transceiver 704 and connected at the opposing end to a counterbalancing transceiver 706 which includes an adjustable counterbalancing torque element. For example, the ordinary transceiver 704 can be a component capable of receiving a fiber connector of the assembly 702 without a counterbalancing element, and the counterbalancing transceiver 706 can be the component 400 including the counterbalancing torque element 300.

Transceiver 706 can be operatively or communicatively connected to a control system 708 (e.g., a controller, or the like) such that the transceiver 706 (or a sensor associated with the transceiver 706) supplies or transmits optical performance data to the control system 708. The control system 708 can in turn be linked to a servo motor 710 mounted or operatively connected to the transceiver 706 in such a manner as to selectively adjust the counterbalancing torque imparted by the counterbalancing torque element 300 within transceiver 706 Control system 708 can command the servo motor 710 to adjust the torque of the counterbalancing torque element 300 within transceiver 706 and can use optical performance data from the transceiver 706 to determine the proper adjustment setting for optimum optical performance of the system 700.

Control system 708 can monitor the optical performance data continuously (e.g., in real-time), and if optical performance changes due to external factors, e.g., changes in system temperature, or the like, the servo motor 710 can be automatically commanded to adjust the torque imparted by the counterbalancing torque element 300 accordingly. The system 700 thereby provides a feedback control loop for automatic or real-time adjustment of the torque provided by the exemplary fiber optic component to ensure optimal optical performance is maintained.

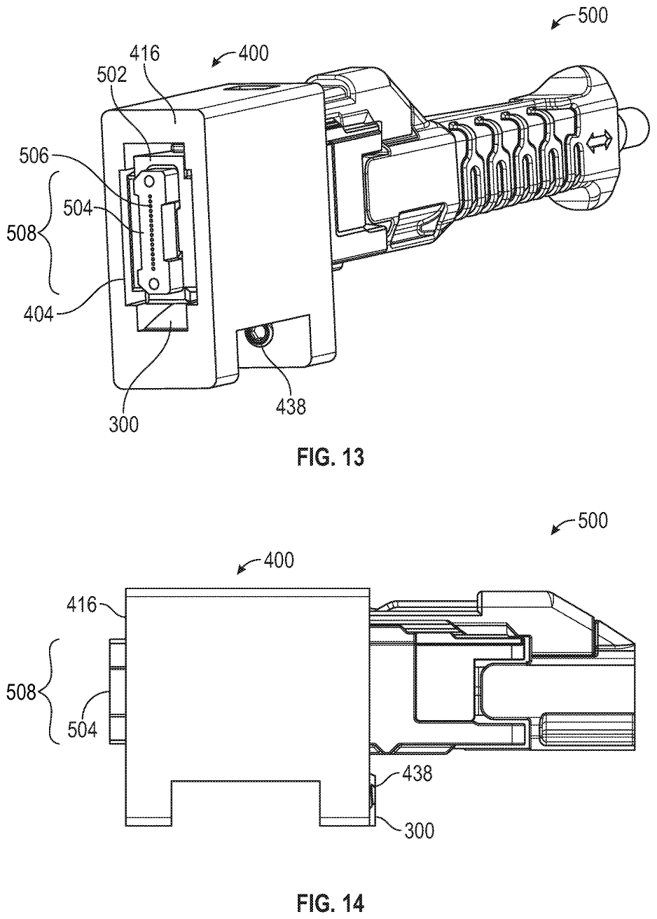

With reference to FIGS. 13 and 14 are perspective views of a fiber optic connector 500 releasably engaged with an exemplary component 400. The connector 500 includes a body 502 which is at least partially received within the opening 404 of the component 400. The end of the body 502 includes a substantially planar or flat face 504 with fibers 506 extending therefrom, generally forming a ferrule 508. Although illustrated as having a single ferrule 508, in some embodiments, the connector 500 can include one or more ferrules 508, and the principle of contact pressure balance across the faces 504 of such a plurality of ferrules 508 can be functionally equivalent to the discussion herein for a single ferrule 508. As the connector 500 is inserted into the opening 404 of the component 400, the element 300 applies a reactive force to the bottom of the connector 500, resulting in an upward torque force. Such torque force results in the connector 500 pivoting in a clockwise direction (in the view of FIG. 14), substantially aligning the parallel position of the face 504 with the face 416. This alignment ensures that the fibers 506 are uniformly oriented relative to the face 416 of the component 400, reducing the variability of optical performance during connectivity of the connector 500. It should be understood that the face 416 of the component 400 is mountable to an active device, such that upon insertion of the connector 500 into the component 400, a fiber optic connection is achieved between the active device and the connector 500.

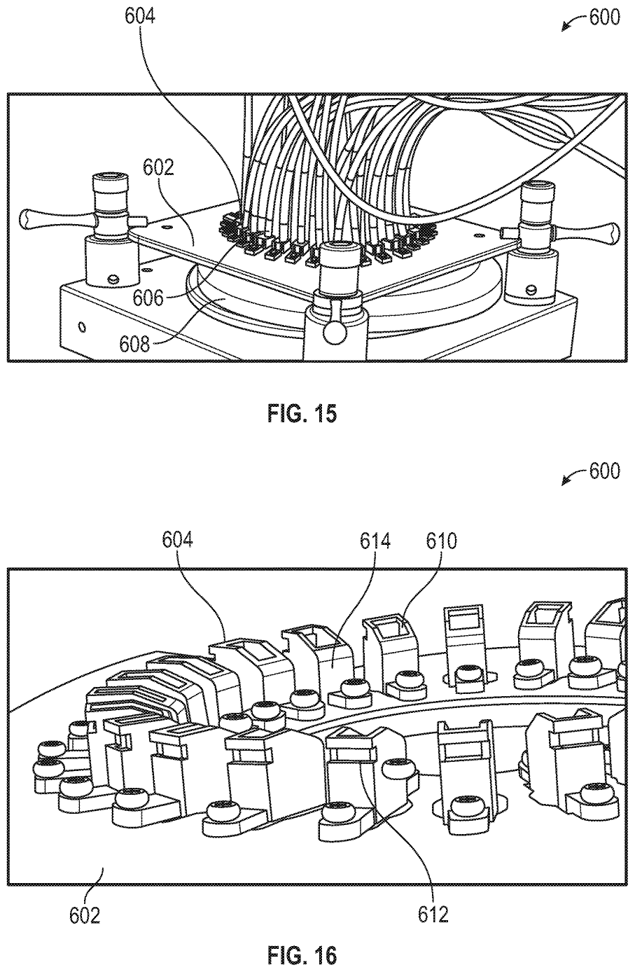

As discussed herein, the connector-receiving component configuration including the counterbalancing torque element can be used for a variety of structures capable of receiving a fiber optic connector. As a non-limiting example, FIGS. 15 and 16 are perspective and detailed views of a connector-receiving component system 600 in the form of a polishing fixture. The system 600 generally includes a platform 602 upon which one or more connector-receiving components 604 are mounted. The components 604 essentially form an active device receptacle or transceiver. In some embodiments, the components 604 can be radially mounted along a central longitudinal axis. Each component 604 is configured to releasably receive a fiber optic connector 606 in an orientation perpendicular to the platform 602. A polishing element 608 can be rotated to simultaneously polish the ferrules of each of the connectors 606. In conventional polishing fixtures, the ferrules of the connector 606 may not be perfectly aligned/perpendicular with the polishing element 608, resulting in subpar performance of the connector 606. The system 600 (and particularly the components 604) ensure that the connectors 606 and ferrules are oriented perpendicularly to the polishing element 608 for accurate polishing of the ferrules, resulting in higher performance of the connectors 606. In some embodiments, component 604 may be configured or oriented at an angle of about, e.g., 8°, relative to perpendicular to the platform 602, in order to achieve angle polish of the ferrules of the connectors 606. In these embodiments, the function of the counterbalancing torque elements is substantially the same as in the perpendicular configuration shown in FIGS. 15 and 16.

In particular, each component 604 can be substantially similar in structure and/or function to the component 400, except for the distinctions noted herein. The component 604 includes a body with an opening 610 extending into a hollow interior which is configured to at least partially receive the connector 606. The component 604 includes a slot or opening 612 configured to releasably engage with a latch of the connector 606 for maintaining the connector 606 in the perpendicular orientation. The component 604 includes the counterbalancing torque element 300 disposed within the interior on, against or adjacent to an inner surface of a bottom wall 614 of the component 604 to impart a corrective balancing force on the bottom surface of the connector 606, thereby ensuring proper alignment of the connector 606 within the opening 610 and alignment of the ferrules with the polishing element 608. An adjustment mechanism can be included with the component 604 to allow for adjustability of the amount of counterbalancing force imparted by the element 300 on the connector 606, which results in customized optimization of the evenness of contact/alignment.

The component 604 (with the biasing or counterbalancing force from the element 300) ensures that the ferrules of the connector 606 are oriented as flat as possible to apply polishing with the polishing element 608, thereby eliminating or reducing polishing bias. Elimination or reduction of polishing bias significantly improves the performance of the connector 606. The connectors 606 can be manufactured in an optimal and efficient manner, allowing for polishing of the previously assembled connector 606 (rather than polishing ferrules and subsequently assembling the connector 606).

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A counterbalancing element for a fiber optic connector-receiving component, the fiber optic connector-receiving component including a body defining a proximal end and a distal end, an opening extending into an interior of the body, the opening configured to accept a fiber optic connector, the counterbalancing element comprising:
a flexible body section configured and dimensioned to be at least partially inserted into the interior of the fiber optic connector-receiving component through the opening of the fiber optic connector-receiving component; and
means for retaining the flexible body section relative to the fiber optic connector-receiving component such that the flexible body section remains at least partially within the interior of the fiber optic connector-receiving component;
wherein the flexible body section is configured to be displaced upon insertion of the fiber optic connector into the opening of the fiber optic connector-receiving component; and
wherein displacement of the flexible body section imparts a biasing force on the fiber optic connector.

2. The counterbalancing element of claim 1, wherein the flexible body section is fabricated from spring steel or a resilient material.

3. The counterbalancing element of claim 1, wherein the flexible body section extends between proximal and distal ends of the flexible body section, the flexible body section defining a convex configuration relative to horizontal between the proximal and distal ends of the flexible body section.

4. The counterbalancing element of claim 1, wherein the flexible body section extends between a first edge at a proximal end of the flexible body section and a second edge at a distal end of the flexible body section, and wherein the counterbalancing element comprises a first flange extending from the first edge and a second flange extending from the second edge.

5. The counterbalancing element of claim 4, wherein the first and second flanges extend perpendicularly from the first and second edges, and extend parallel to each other.

6. The counterbalancing element of claim 4, comprising a lip extending inwardly from the second flange and under the flexible body section.

7. The counterbalancing element of claim 4, wherein the first flange is configured to be positioned within a slit formed in the body of the fiber optic connector-receiving component and the second flange is configured to be positioned against a face of the body of the fiber optic connector-receiving component to secure the counterbalancing element relative to the fiber optic connector-receiving component.

8. A fiber optic connector-receiving component, comprising:
a body defining a proximal end and a distal end;
an opening extending into an interior of the body, the opening configured to accept a fiber optic connector; and
a counterbalancing element, the counterbalancing element including:
a flexible body section configured and dimensioned to be at least partially disposed within the interior of the body;
wherein the flexible body section is configured to be displaced upon insertion of the fiber optic connector into the opening; and
wherein displacement of the flexible body section imparts a biasing force on the fiber optic connector.

9. The fiber optic connector-receiving component of claim 8, wherein the counterbalancing element is configured to impart the biasing force on the fiber optic connector to maintain alignment of ferrules of the fiber optic connector relative to the body of the fiber optic connector-receiving component.

10. The fiber optic connector-receiving component of claim 8, wherein the biasing force is a counterbalancing force configured to counter an opposing torque force during latching of the fiber optic connector with a latching point formed in the body.

11. The fiber optic connector-receiving component of claim 8, wherein the fiber optic connector-receiving component is an active device receptacle and the biasing force on the fiber optic connector maintains alignment of ferrules of the fiber optic connector relative to an active device.

12. The fiber optic connector-receiving component of claim 8, wherein the fiber optic connector-receiving component is associated with a polishing fixture and the biasing force on the fiber optic connector maintains alignment of ferrules of the fiber optic connector relative to a polishing surface.

13. The fiber optic connector-receiving component of claim 8, comprising an adjustment mechanism configured to engage with the counterbalancing element to selective increase or decrease the biasing force imparted by the flexible body section of the counterbalancing element on the fiber optic connector.

14. The fiber optic connector-receiving component of claim 13, wherein the adjustment mechanism includes a feedback control loop including a controller configured to receive optical performance in real-time associated with the fiber optic connector and to automatically adjust the biasing force imparted on the fiber optic connector with the counterbalancing element to optimize the optical performance.

15. A fiber optic connector-receiving component system, comprising:
a fiber optic connector-receiving component including:
a body defining a proximal end and a distal end;
an opening extending into an interior of the body, the opening configured to accept a fiber optic connector; and
a counterbalancing element, the counterbalancing element including:
a flexible body section configured and dimensioned to be at least partially inserted into the interior of the fiber optic connector-receiving component through the opening of the fiber optic connector-receiving component; and
means for retaining the flexible body section relative to the fiber optic connector-receiving component such that the flexible body section remains at least partially within the interior of the fiber optic connector-receiving component;
wherein the flexible body section is configured to be displaced upon insertion of the fiber optic connector into the opening of the fiber optic connector-receiving component; and
wherein displacement of the flexible body section imparts a biasing force on the fiber optic connector.

16. The fiber optic connector-receiving component system of claim 15, wherein the body of the fiber optic connector-receiving component includes a track configured and dimensioned complementary to the fiber optic connector.

17. The fiber optic connector-receiving component system of claim 16, comprising a slit formed in a bottom surface of the track and offset from the proximal end or the distal end of the body.

18. The fiber optic connector-receiving component system of claim 17, wherein a first flange of the counterbalancing element is configured to be positioned within the slit and a second flange of the counterbalancing element is configured to be positioned against a face of the body of the fiber optic connector-receiving component to secure the counterbalancing element relative to the fiber optic connector-receiving component.

19. The fiber optic connector-receiving component system of claim 15, wherein the fiber optic connector-receiving component comprises an adjustment mechanism configured to engage with the counterbalancing element to selective increase or decrease the biasing force imparted by the flexible body section of the counterbalancing element on the fiber optic connector.

20. The fiber optic connector-receiving component system of claim 19, wherein the adjustment mechanism includes a feedback control loop including a controller configured to receive optical performance in real-time associated with the fiber optic connector and to automatically adjust the biasing force imparted on the fiber optic connector with the counterbalancing element to optimize the optical performance.
